(19) United States
(12) Patent Application Publication
(10) Pub. No.: US 2017/0286564 A1
(43) Pub. Date: Oct. 5, 2017

(54) APPARATUSES, METHODS, AND COMPUTER PROGRAM PRODUCTS FOR AUTOMATIC EXTRACTION OF DATA

(71) Applicant: Change Healthcare LLC, Alpharetta, GA (US)

(72) Inventor: James McCudden, Amherst, MA (US)

(73) Assignee: Change Healthcare LLC, Alpharetta, GA (US)

(21) Appl. No.: 15/084,962

(22) Filed: Mar. 30, 2016

(51) Int. Cl. G06F 17/30; G06F 9/44

(52) U.S. Cl. CPC G06F 17/30917; G06F 8/31; G06F 17/30979

(57) ABSTRACT

Apparatuses, methods, and computer program products are provided for extracting data from a data platform using a generic extraction code that derives relationships between different items of data based on the code structure itself (e.g., the structure of the stored data) to determine the relevant topic records for extraction. The extraction code is instantiated using the requested data type by calling a generic extraction code, accessing relationship data associated with serialized data stored in a data platform using the generic extraction code, such as with reference to an ontology library of the API. A type of a data item and a relationship of the data item with other data items stored in the data platform may thus be determined based on a structure of the serialized data accessed. A requested data item is then extracted from the data platform using the instantiated extraction code.

### BACKGROUND

In the digital age, data is generated by various sources in vast amounts. As the amount of data that is generated and stored grows, so does user demand for quick and easy access to the right data that addresses the user's needs.

Moreover, these stores of data are typically relevant to different users addressing the same problems. Thus, it is becoming more important to ensure that the right data is accessible to different users at different locations who are in need of the data.

### BRIEF SUMMARY

In particular, data platform developers, such as developers of software applications in the field of healthcare, have experienced a growing need for the ability to access a number of related records for a given topic for which data is stored, but without having to know the topic's particular data structure (e.g., the specialized programming code that is reflective of that data structure).

Accordingly, improved apparatuses, methods, and computer program products according to embodiments of the invention are described herein that provide for a generalized extraction of data that derives relationships between different items of data from the code structure itself (e.g., the structure of the stored data), such as with reference to an ontology library, to determine the relevant topic records for extraction.

In some embodiments, an apparatus is provided for extracting data stored in a data platform. The apparatus comprises at least one processor and at least one memory including computer program code. The at least one memory and the computer program code may be configured to, with the processor, cause the apparatus to at least receive a request to extract data, wherein the request includes a requested data type. The apparatus may be further caused to instantiate an extraction code using the requested data type. Instantiating the extraction code may comprise calling a generic extraction code and accessing relationship data associated with serialized data stored in a data platform using the generic extraction code. The relationship data may be stored in an ontology library, and the relationship data may be indicative of a structure of the serialized data accessed. A requested data item may then be extracted from the data platform using the instantiated extraction code.

In some cases, the at least one memory and the computer program code may be configured to, with the processor, cause the apparatus to extract the requested data item by extracting each data item related to the requested data type based on the relationship of the data item determined. The at least one memory and the computer program code may further be configured to, with the processor, cause the apparatus to instantiate the extraction code by accessing definitions of protocol objects in a protocol buffer code used to serialize the serialized data. The apparatus may, in some embodiments, comprise the ontology library.

In some embodiments, the request to extract data may be a batch request. Additionally or alternatively, the at least one memory and the computer program code may be further configured to, with the processor, cause the apparatus to extract the requested data item by generating a JSON file. The generic extraction code in some cases, may be in C# or Java programming language.

In other embodiments, a method and a computer program product for extracting data stored in a data platform are provided. The method and/or computer program product may include receiving a request to extract data, wherein the request includes a requested data type, and instantiating an extraction code using the requested data type. Instantiating the extraction code may comprise calling a generic extraction code and accessing relationship data associated with serialized data stored in a data platform using the generic extraction code. The relationship data may be stored in an ontology library, and the relationship data may be indicative of a structure of the serialized data accessed. Moreover, a requested data item may be extracted from the data platform using the instantiated extraction code.

In some cases, extracting the requested data item may comprise extracting each data item related to the requested data type based on the relationship of the data item determined. Additionally or alternatively, instantiating the extraction code may comprise accessing definitions of protocol objects in a protocol buffer code used to serialize the serialized data. In some cases, an apparatus running the extraction code may comprise the ontology library.

The request to extract data may be a batch request. In some cases, extracting the requested data item may comprise generating a JSON file.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates a network environment in accordance with one example embodiment of the present invention;

FIG. 2 is a schematic representation of an apparatus in accordance with one example embodiment of the present invention;

FIG. 3 is a schematic representation of interrelationships between different topics in accordance with one example embodiment of the present invention;

FIG. 4 is a flow chart showing a process of serializing and storing data in accordance with one example embodiment of the present invention;

FIG. 5 is a schematic representation of communications occurring between a requestor, an apparatus, and a data platform in accordance with one example embodiment of the present invention; and

FIGS. 6A and 6B are flow charts illustrating a method for automatically extracting data stored in a data platform according to an example embodiment of the present invention.

### DETAILED DESCRIPTION

Embodiments of the present invention now will be described more fully hereinafter with reference to the accompanying drawings, in which some, but not all embodiments of the invention are shown. Indeed, embodiments of this invention may be embodied in many different forms and should not be construed as limited to the embodiments set forth herein; rather, these embodiments are provided so that this disclosure will satisfy applicable legal requirements. Like reference numerals refer to like elements throughout.

Although the description that follows may include examples in which embodiments of the invention are used in the context of healthcare data generated by healthcare organizations, such as hospitals, doctors' offices, and pharmacies, it is understood that embodiments of the invention may be applied to data that is generated and used in numerous settings, including in other types of healthcare organizations and in organizations outside the field of healthcare. Moreover, embodiments of the invention may be used for extracting data other than medical data, such as data from educational records, criminal record, financial records, and other types of data records.

In the field of healthcare, as an example, electronic health information exchange (HIE) allows doctors, nurses, pharmacists, other health care providers, and patients to appropriately access and securely share a patient's vital medical information electronically, in an effort to improve the speed, quality, safety, and cost of patient care. For example, a doctor's diagnosis and notes regarding a patient may result in data that is entered into the patient's record. A prescription written by that doctor or another doctor may be added as data in the patient's record. A subsequent summary of the patient's outpatient surgery, medicines administered, prognosis; the results of the patient's bloodwork or other tests; the patient's medical history from a prior doctor—all of this information can be data that is stored for later access by healthcare professionals for care of that patient.

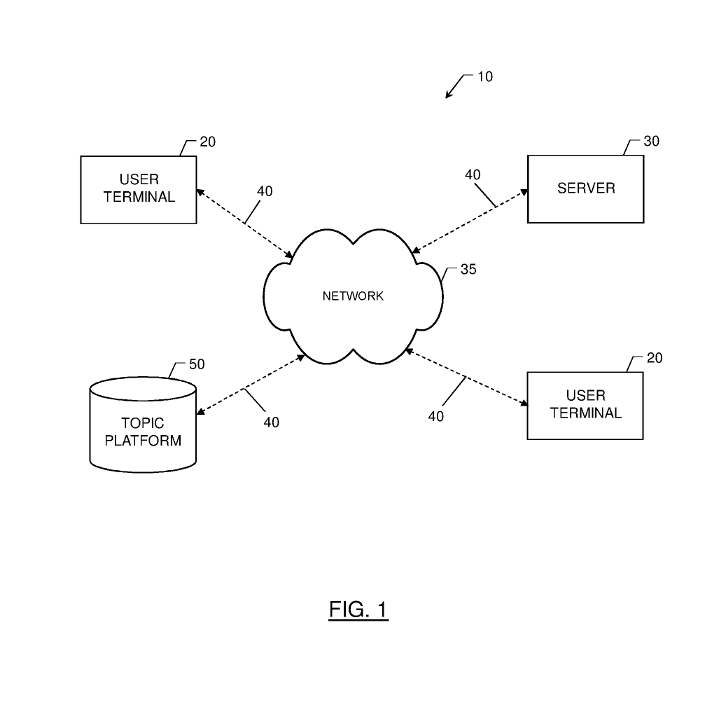

With reference to FIG. 1, for example, a network environment 10 is illustrated in which data (e.g., data regarding a patient's health as in the example above) may be input from various sources (e.g., doctors' offices, hospitals, pharmacies, etc. in the example above) via user terminals 20, such as fixed devices (e.g., desktop computers, etc.) or mobile devices (e.g., laptop computers, tablets, etc.). A user terminal 20 may, for example, be configured to execute or access an application (e.g., a software program) that generates a user interface on a display of the user terminal for allowing the user to enter and/or classify various types of information regarding the data. In some cases, the application may be stored locally on the user terminal 20, such as on a memory of the user terminal (e.g., the fixed or mobile device), whereas in other cases the application may be stored on and accessed from a server 30 that is connected to a network 35 to which the user terminal is also connected, e.g., via a network connection 40.

The data that is collected or generated via the user terminals 20 may in turn be processed and stored in a database, such as a database that is associated with or part of a data platform 50. In FIG. 1, the data platform 50 is depicted as being separate from the server 30 on which the application resides and is connected to the network 35 via a network connection 40; however, in some embodiments, the data platform may be part of the application and/or may comprise a database that is stored on a memory of the server 30 on which the application resides or on a different server (not shown) with which the application server is configured to communicate.

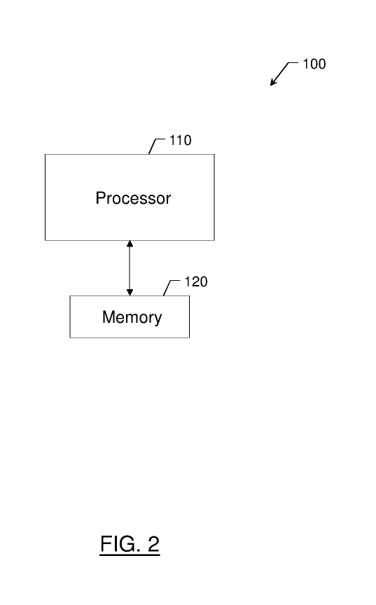

FIG. 2 shows a schematic representation of an apparatus 100 configured for extracting data according to embodiments of the invention described herein, which may be included in or embodied by the server 30 shown in FIG. 1. In this regard, the apparatus 100 may comprise at least one processor 110 and at least one memory 120 including computer program code configured to cause various functions to be carried out for extracting data from the data platform as described in greater detail below. The processor 110 (and/or co-processors or any other processing circuitry assisting or otherwise associated with the processor 110) may be in communication with the memory 120 via a bus for passing information among components of the apparatus 100 and/or system of apparatuses, such as a network of servers in a networking application. The memory 120 may include, for example, one or more volatile and/or non-volatile memories. In other words, for example, the memory 120 may be an electronic storage device (e.g., a computer readable storage medium) comprising gates configured to store data (e.g., bits) that may be retrievable by a machine (e.g., a computing device like the processor 110). The memory 120 may be configured to store information, data, content, applications, instructions, or the like for enabling the apparatus and/or system to carry out various functions in accordance with an example embodiment of the present invention. For example, the memory 120 may be configured to buffer input data for processing by the processor 110. Additionally or alternatively, the memory 120 may be configured to store instructions for execution by the processor 110. Moreover, in some embodiments, the data platform 50 may be embodied in the memory 120, as noted above.

The apparatus 100 may, in some embodiments, be a server or a fixed communication device or computing device configured to employ an example embodiment of the present invention. However, in some embodiments, the apparatus 100 may be embodied as a chip or chip set. In other words, the apparatus 100 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 100 may therefore, in some cases, be configured to implement an embodiment of the present invention on a single chip or as a single “system on a chip.”

The processor 110 may be embodied in a number of different ways. For example, the processor 110 may be embodied as one or more of various hardware processing means such as a coprocessor, a microprocessor, a controller, a digital signal processor (DSP), a processing element with or without an accompanying DSP, or various other processing circuitry including integrated circuits. As such, in some embodiments, the processor 110 may include one or more processing cores configured to perform independently. A multi-core processor may enable multiprocessing within a single physical package. Additionally or alternatively, the processor 110 may include one or more processors configured in tandem via the bus to enable independent execution of instructions, pipelining and/or multithreading.

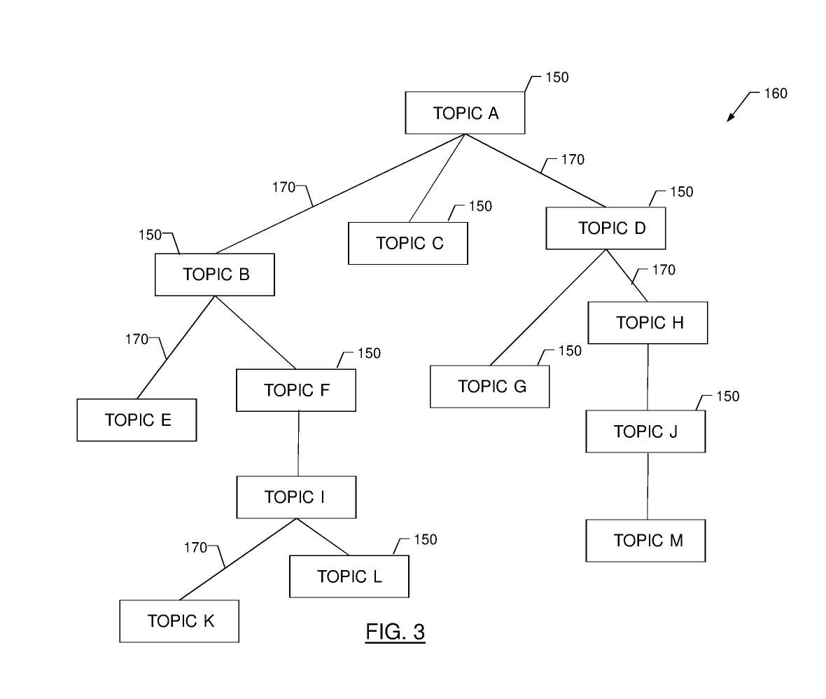

In an example embodiment, whether configured by hardware or software methods, or by a combination thereof, the processor 110 may represent an entity (e.g., physically embodied in circuitry) capable of performing operations according to an embodiment of the present invention while configured accordingly. Thus, for example, the processor 110 may be configured to receive inputted data from a user terminal 20 (FIG. 1), parse and de-duplicate the data, serialize the data, and/or store the serialized data in the data platform 50 (FIG. 1), as described in greater detail below with reference to FIG. 3. In some cases, the processor 110 and the memory 120 may be embodied by the same apparatus 100, such as on a particular server 30 (FIG. 1), whereas in other cases the processor and the memory may reside on different components that are configured to communicate over a network 35, such as on two or more servers connected to a network (e.g., the Internet).

Regardless of the specific architecture of the network environment 10 and its components, only one example of which is shown in FIG. 1, or the particular configuration of the apparatus 100 shown in FIG. 2, embodiments of the invention described herein provide a generalized extraction method that uses the structure of the serialized data stored in the data platform and the possible relationships between topics that are defined in an application platform interface (API) library to determine the topic records and related topics to be extracted based on a particular request for data. In this regard, a “topic” can be defined as a class of data (e.g., a class of objects in object-oriented programming) that is stored in the data platform 50, where the “objects” are entities that combine state (e.g., data), behavior (e.g., procedures or methods), and/or identity (e.g., uniqueness of an object with respect to other objects). The “relationship” defined by the topics can be defined as the connections between the different objects, classes, and/or topics.

With reference to FIG. 3, for example, the relationships between topics (e.g., classes of objects) stored in the data platform 50 of FIG. 1 may be represented as an interconnection of nodes 150 on a graph 160, as shown. In the depicted example, Topic A may be a class of objects that includes data regarding a patient's first name and last name; Topic B may be a class of objects that includes data regarding a patient's medication history; Topic C may be a class of objects that includes data regarding a patient's history of hospital visits, and so on. The relationships between the various nodes 150 in the graph 160 shown in the example of FIG. 3 are thus represented by the lines 170 interconnecting the different nodes.

According to conventional techniques for data extraction, for example, topic data and the relationships in and between the topics are typically coded with the class of objects saved in the data platform at the time the original data is stored. Such coded topics and relationships must be manually changed if the topic or the relationships defined by the topics changes, such us when new data or topics of data are added to the data platform. By using the structure of the data itself to define relationships on a continual basis in an ontology library of the API according to embodiments of the present invention, any changes to the data and its structure are automatically and dynamically discernible, and the correct data pertaining to a particular request can be identified and extracted regardless of changes or additions to the stored topics or relationships. This allows the extraction code to remain static, while the API library is changed to reflect new relationships because the extraction code uses the ability of the API library to describe the relationships between topics in a way that can be programmatically queried via reflection, as described herein.

Embodiments of the invention described herein make use of the data platform's application platform interface (API) to select all records for a given topic, either under a streaming or a “one record at a time” methodology. In this regard, an API is a set of routines, protocols, and/or tools that are used to build software and applications, such that a programmer can use an API to interact with hardware associated with the devices executing the software and applications being developed. Thus, the API associated with the data platform 50 of FIG. 1 may include, for example, a library (e.g., an ontology library) with specifications for routines, data structures, object classes, and variables associated with the data stored in the data platform. In the embodiments described herein, as new data and topics are added to the data platform (or removed or changed), new or modified relationships are described in the API library, which is then accessible by the extraction code for determining the particular data to be extracted, as described below.

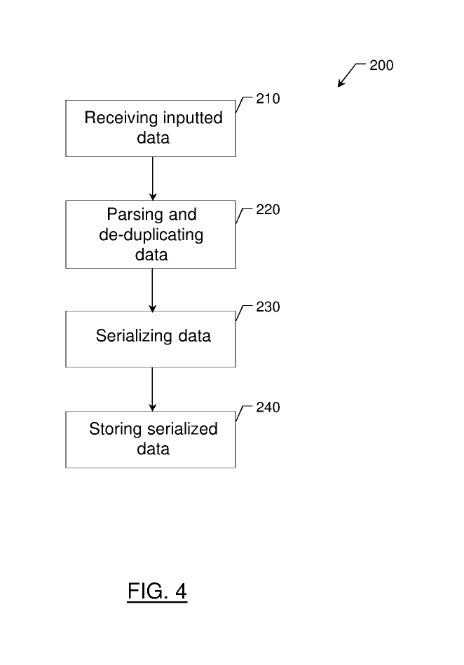

With reference to FIGS. 1 and 4, a user may input data into the system via the user terminal 20 shown in FIG. 1, such as by creating a new record for a patient by typing in a patient's first and last name. This data may be received by a processor (e.g., the processor 110 of the apparatus 100 shown in FIG. 2 or the like) at step 210 of the process 200 illustrated in FIG. 4. The received data may then be parsed and de-duplicated at step 220, for example to remove redundant entries or unnecessary portions of entries. The parsed and de-duplicated data may then be serialized into an array of bytes, such as by a Google® protocol buffer or the like, at step 230, and the serialized data may then be stored in the data platform 50 of FIG. 1 at step 240.

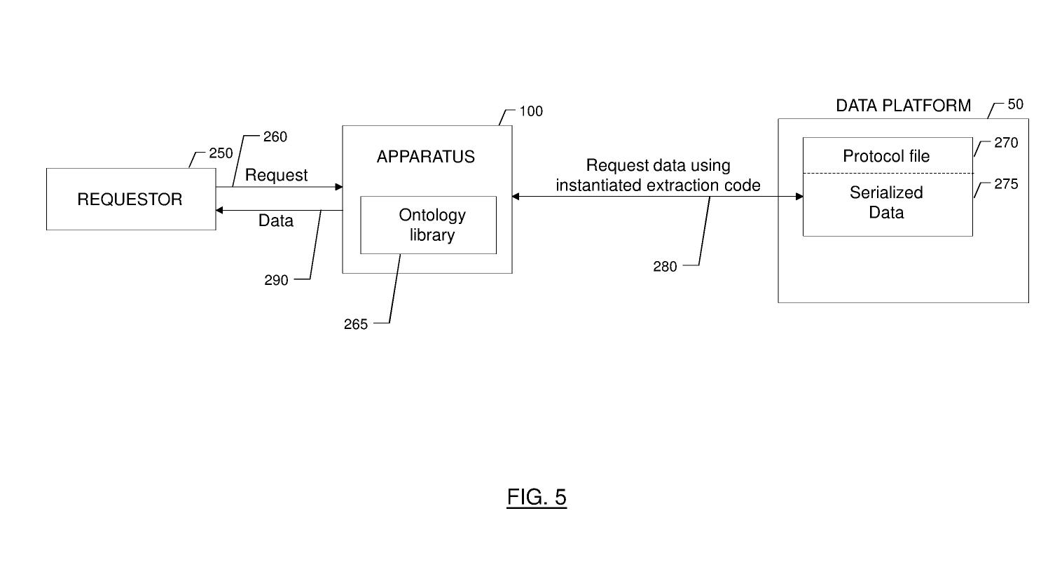

Turning to FIG. 5, when a request for data is made by a user, such as via a user terminal 20 of FIG. 1, the requestor 250 (e.g., the user terminal or an associated processor via which the request was received from the user) in turn may make a request 260 to the apparatus 100. For example, a request may be made by a user to extract a consolidated patient record consisting of medications and procedures. The patient information (e.g., demographics) may be stored separately from medication and procedure records. When a consolidated extract request is made, the data (e.g., medications) related to the topic being requested (e.g., patient data in this example) may thus be determined at extraction time using the stored patient data and the relationship between patient and medication data, as defined in the API library according to the embodiments described herein.

Accordingly, the apparatus 100 of FIG. 2 may be caused (via the processor 110) to receive a request 260 to extract data, where the request includes requested data type. The apparatus 100, in turn, may then need to determine a structure of the data in the data platform 50 according to embodiments of the claimed invention, such that the data to be extracted can be properly identified (e.g., automatically, without the need to access hand-coded topic and relationship files). The apparatus 100 may, in some cases, determine the structure of the data with reference to a protocol file that is created upon the serialization of the data at step 230 of FIG. 4, such as by the Google® protocol buffer in the example above.

In this regard, the apparatus 100 may be caused to instantiate an extraction code using the requested data type. Instantiating the extraction code may comprise calling a generic extraction code and accessing information associated with serialized data stored in the data platform using the generic extraction code. Thus, the apparatus 100 may make an API call to the ontology library 265 using the generic extraction code, which in some embodiments may result in accessing the protocol file 270 associated with the serialized data 275. The generic extraction code may, for example, use C# (“C sharp”) or Java programming language generics to find the protocol definition class for the class of data that is being extracted.

The protocol file for each class of objects defines data that is stored in the data platform according to its topic and also defines what other data is related to the topic. In some embodiments, the at least one memory and the computer program code of the apparatus 100 may be further configured to, with the processor, case the apparatus to instantiate the extraction code by referencing the ontology library that was updated during serialization of the data for storage in the data platform (as described above) and using reflection to determine information about the class of data. In some embodiments, definitions of protocol objects in a protocol buffer code used to serialize the serialized data are accessed. The protocol is thus determined based on the topic to be extracted, and the topic is included in or otherwise determined from the request received from the user with respect to the requested data type (and thus is part of the request 260 transmitted to the apparatus 100).

As noted above, in some cases, the protocol file may be stored in an ontology library 265 of the data platform 50, which may include the formal naming and definition types for each topic, its properties, and the interrelationships of entities. Each time a new topic is added to the data platform, that topic is added to the ontology library (e.g., through the protocol file that is created when the associated data is serialized, as described above). Moreover, each time a relationship is updated (e.g., a new topic is introduced that is related to other pre-existing topics), the new or modified relationship may be reflected in the ontology library. Thus, the ontology library defines what the stored topics represent (e.g., patient demographics, medications, etc.). The ontology library further defines the possible relationships between the topics (e.g., that a mediation that has been administered has a relationship to a patient to whom it has been administered).

Instantiating the extraction code may thus further comprise determining a type of a data item and a relationship of the data item with other data items stored in the data platform based on a structure of the serialized data accessed, where the structure is indicated in the ontology library, for example. Accordingly, an extraction code may be instantiated using the requested data type. Instantiating the extraction code (e.g., running an “extractor”) may comprise calling a generic extraction code, and accessing relationship data associated with serialized data stored in a data platform using the generic extraction code, wherein the relationship data is defined in an ontology library, and wherein the relationship data is indicative of a structure of the serialized data accessed.

In some cases, a set of defined relationships may be accessed from the protocol file and examined at the time of extraction (e.g., in response to the API call to the ontology library 265 made using the generic extraction code). Using the type of data items and relationships that are determined with reference to the ontology library 265, the extraction code can be instantiated, and the instantiated extraction code 280 can be used to access the serialized data 275 and extract the requested data item from the data platform. For example, the instantiated extraction code 280 may cause each possible relationship that was defined in the ontology library to be examined in the serialized data to determine whether data is defined for the related topic. If data exists, that relationship is extracted along with the topic data and returned 280 to the apparatus 100. In this way, the apparatus 100 may be caused (via the processor 110) to extract the requested data by extracting each data item related to the requested data type based on the relationship of the data item determined. The extracted data items may, in some cases, be stored by the apparatus 100, such as in a memory 120 of the apparatus (FIG. 2) until it is ultimately delivered 290 to the requestor to be conveyed to the user, such as in a batch request operation where multiple data items responsive to multiple requests are extracted at substantially the same time (e.g., in parallel). The at least one memory and the computer program code may, for example, be configured to, with the processor, cause the apparatus to extract the requested data item by generating a JSON file.

Accordingly, as described above, data items can be extracted in an automatic process that relies on the static definition of the topics, protocols, and relationships of those topics. In this regard, because a generic extraction code is initially used to determine relationships with reference to the ontology library in the API, underlying changes to a topic, protocol, or relationship do not require any changes to be made to the extraction code. Rather, any such changes would be reflected in the instantiation of the extraction code based on the determined topics and relationships at runtime. The ontology library, for example, may define what relationships can exist between topics. In some embodiments, however, the actual relationships stored between topics at data ingest time can be some, all, or none of the possible relationships. Thus, the generic extraction code goes through all possible relationships that are defined in the ontology library and finds the ones that are present. The instantiated relationships are thus not stored in the library in such examples, but only the definitions of what relationship are possible would be found in the ontology library.

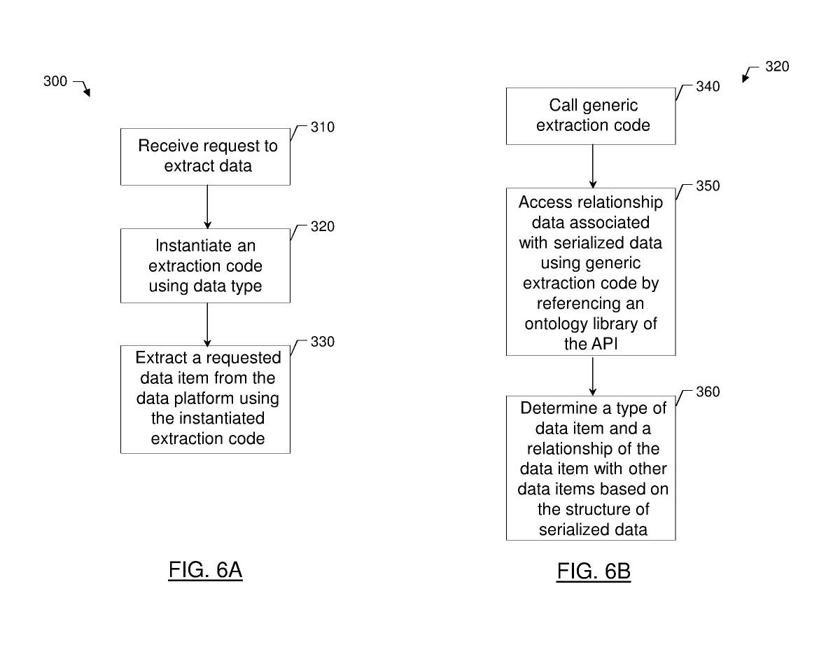

With reference to FIG. 6A, in some embodiments, a method 300 for extracting data stored in a data platform is also provided. According to embodiments of the method, a request to extract data may be received at Block 310 (e.g., by an apparatus as described above), where the request includes a requested data type. An extraction code may be instantiated using the requested data type at Block 320. As described above and depicted in FIG. 6B, instantiating the extraction code at Block 320 may comprise calling a generic extraction code at Block 340 and accessing relationship data associated with serialized data stored in a data platform using the generic extraction code at Block 350, wherein the relationship data is defined in an ontology library, and the relationship data is indicative of a structure of the serialized data accessed. A type of a data item and a relationship of the data item with other data items stored in the data platform may thus be determined based on a structure of the serialized data accessed at Block 360. According to the method 300 of FIG. 6A, a requested data item may be extracted from the data platform using the instantiated extraction code at Block 330.

Example embodiments of the present invention have been described above with reference to block diagrams and flowchart illustrations of methods, apparatuses, and computer program products. In some embodiments, certain ones of the operations above may be modified or further amplified as described below. Furthermore, in some embodiments, additional optional operations may be included. Modifications, additions, or amplifications to the operations above may be performed in any order and in any combination.

It will be understood that each operation, action, step and/or other types of functions shown in the diagram (FIGS. 6A and 6B), and/or combinations of functions in the diagram, can be implemented by various means. Means for implementing the functions of the flow diagrams, combinations of the actions in the diagrams, and/or other functionality of example embodiments of the present invention described herein, may include hardware and/or a computer program product including a non-transitory computer-readable storage medium (as opposed to or in addition to a computer-readable transmission medium) having one or more computer program code instructions, program instructions, or executable computer-readable program code instructions stored therein.

For example, program code instructions associated with FIGS. 6A and 6B may be stored on one or more storage devices, such as a memory 120 of the apparatus 100, and executed by one or more processors, such as processor 110, shown in FIG. 2. In some cases, for example, the ontology library may be stored on a memory 120 of the apparatus 100. Additionally or alternatively, one or more of the program code instructions discussed herein may be stored and/or performed by distributed components, such as those discussed in connection with the apparatus 100. As will be appreciated, any such program code instructions may be loaded onto computers, processors, other programmable apparatuses or network thereof from one or more computer-readable storage mediums to produce a particular machine, such that the particular machine becomes a means for implementing the functions of the actions discussed in connection with, e.g., FIGS. 6A and 6B and/or the other drawings discussed herein. As such, FIGS. 6A and 6B showing data flows may likewise represent program code instructions that may be loaded onto a computer, processor, other programmable apparatus or network thereof to produce a particular machine.

The program code instructions stored on the programmable apparatus may also be stored in a non-transitory computer-readable storage medium that can direct a computer, a processor (such as processor 110) and/or other programmable apparatus to function in a particular manner to thereby generate a particular article of manufacture. The article of manufacture becomes a means for implementing the functions of the actions discussed in connection with, e.g., FIGS. 6A and 6B. The program code instructions may be retrieved from a computer-readable storage medium and loaded into a computer, processor, or other programmable apparatus to configure the computer, processor, or other programmable apparatus to execute actions to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel by one or more machines, such that multiple instructions are retrieved, loaded, and/or executed together. Execution of the program code instructions may produce a computer-implemented process such that the instructions executed by the computer, processor, other programmable apparatus, or network thereof provides actions for implementing the functions specified in the actions discussed in connection with, e.g., the process illustrated in FIGS. 6A and 6B.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus for extracting data stored in a data platform, the apparatus comprising at least one processor and at least one memory including computer program code, the at least one memory and the computer program code configured to, with the processor, cause the apparatus to at least:
receive a request to extract data, wherein the request includes a requested data type;
instantiate an extraction code using the requested data type, wherein instantiating the extraction code comprises calling a generic extraction code, and accessing relationship data associated with serialized data stored in a data platform using the generic extraction code, wherein the relationship data is defined in an ontology library, wherein the relationship data is indicative of a structure of the serialized data accessed; and
extract a requested data item from the data platform using the instantiated extraction code.

2. The apparatus of claim 1, wherein the at least one memory and the computer program code are configured to, with the processor, cause the apparatus to extract the requested data item by extracting each data item related to the requested data type based on the relationship of the data item determined.

3. The apparatus of claim 1, wherein the at least one memory and the computer program code are configured to, with the processor, cause the apparatus to instantiate the extraction code by accessing definitions of protocol objects in a protocol buffer code used to serialize the serialized data.

4. The apparatus of claim 1, wherein the apparatus comprises the ontology library.

5. The apparatus of claim 1, wherein the request to extract data is a batch request.

6. The apparatus of claim 1, wherein the at least one memory and the computer program code are further configured to, with the processor, cause the apparatus to extract the requested data item by generating a JSON file.

7. The apparatus of claim 1, wherein the generic extraction code is in C# or Java programming language.

8. A method for extracting data stored in a data platform, the method comprising:
receiving a request to extract data, wherein the request includes a requested data type;
instantiating an extraction code using the requested data type, wherein instantiating the extraction code comprises:
calling a generic extraction code, and
accessing relationship data associated with serialized data stored in a data platform using the generic extraction code,
wherein the relationship data is defined in an ontology library, wherein the relationship data is indicative of a structure of the serialized data accessed; and
extracting a requested data item from the data platform using the instantiated extraction code.

9. The method of claim 8, wherein extracting the requested data item comprises extracting each data item related to the requested data type based on the relationship of the data item determined.

10. The method of claim 8, wherein instantiating the extraction code comprises accessing definitions of protocol objects in a protocol buffer code used to serialize the serialized data.

11. The method of claim 8, wherein an apparatus running the extraction code comprises the ontology library.

12. The method of claim 8, wherein the request to extract data is a batch request.

13. The method of claim 8, wherein extracting the requested data item comprises generating a JSON file.

14. A computer program product for extracting data stored in a data platform, wherein the computer program product comprises at least one non-transitory computer-readable storage medium having computer-executable program code portions stored therein, the computer-executable program code portions comprising program code instructions for:
receiving a request to extract data, wherein the request includes a requested data type;
instantiating an extraction code using the requested data type, wherein instantiating the extraction code comprises:
calling a generic extraction code, and
accessing relationship data associated with serialized data stored in a data platform using the generic extraction code,
wherein the relationship data is defined in an ontology library, wherein the relationship data is indicative of a structure of the serialized data accessed; and
extracting a requested data item from the data platform using the instantiated extraction code.

15. The computer program product of claim 14, wherein the program code instructions for extracting the requested data item further comprise program code instructions for extracting each data item related to the requested data type based on the relationship of the data item determined.

16. The computer program product of claim 14, wherein the program code instructions for instantiating the extraction code further comprise program code instructions for accessing definitions of protocol objects in a protocol buffer code used to serialize the serialized data.

17. The computer program product of claim 14, wherein an apparatus executing the program code instructions for instantiating the extraction code comprises the ontology library.

18. The computer program product of claim 14, wherein the request to extract data is a batch request.

19. The computer program product of claim 14, wherein the program code instructions for extracting the requested data item further comprise program code instructions for generating a JSON file.

20. The computer program product of claim 14, wherein the generic extraction code is in C# or Java programming language.
